(19) United States
(12) Patent Application Publication
(10) Pub. No.: US 2012/0186469 A1
(43) Pub. Date: Jul. 26, 2012

(54) INK SUPPLY AMOUNT CONTROL APPARATUS FOR PRINTING PRESS

(76) Inventor: Yutaka Sato, Yamagata (JP)

(21) Appl. No.: 13/349,408

(22) Filed: Jan. 12, 2012

(30) Foreign Application Priority Data
Jan. 25, 2011 (JP) 012738/2011

(51) Int. Cl. B41K 1/38

(52) U.S. Cl. 101/335

(57) ABSTRACT

This invention discloses an ink supply amount control apparatus for a printing press, including a sheet delivery device, printing quality control device, measuring device, and ink amount adjusting device. The sheet delivery device delivers a sheet printed by a printing press. The printing quality control device is provided on the sheet delivery device, and at least adjusts an amount of ink to be printed on the sheet by a manual operation. The measuring device is movably provided on the printing quality control device, and measures color adjustment data for each of color patches printed in the margins of the sheet. The ink amount adjusting device includes a control unit which automatically adjusts the amount of ink to be printed on the sheet, based on the comparison result between the color adjustment data measured by the measuring device, and reference values set in advance.

### BACKGROUND OF THE INVENTION

The present invention relates to an ink supply amount control apparatus for a printing press, which adjusts the amount of ink to be supplied from a printing unit while comparing a printed sheet and a printing sample with each other.

Conventionally, an ink supply amount control apparatus with which the operator manually adjusts the amount of ink to be supplied from an inking device of a printing press is set on a sheet delivery device of the printing press, together with a printing sample table on which a printed printing product is placed, for the purpose of saving space, as disclosed in U.S. Pat. No. 6,606,949 (literature 1).

On the other hand, in an ink supply amount control apparatus disclosed in Japanese Patent Laid-Open No. 63-144219 (literature 2), a color bar which is formed by color patches of respective colors and printed to fall within the range of each ink fountain key of a printing press is printed in the top, bottom, or center margin of a sheet to extend laterally (in the sheet widthwise direction), simultaneously with printing of an image on the sheet. The density value (or color value) of the printed color patch of each color is automatically measured by an automatic scanning measuring device which moves laterally, typically a scanning densitometer. The density value (or color value) of the color patch of each color measured by the scanning densitometer is compared with a reference density value for this color (or a reference color value for this color), the opening ratio of the ink fountain key of this color is adjusted in accordance with the difference between the measured value and the reference value, and a printing product is printed using the reference density value for this color (or the reference color value for this color).

The scanning densitometer as described above is provided separately from the ink supply amount control apparatus, and therefore requires an additional space. Also, to control the ink supply amount, the operator must move back and forth between the ink supply amount control apparatus and the scanning densitometer, thus imposing a heavy burden on the operator.

Moreover, when an automatic scanning measuring device (scanning densitometer) is provided on the ink supply amount control apparatus set on the sheet delivery device of the printing press, a printing sample table must further be mounted in the limited space. In this case, the tilt angle of the surface of the printing sample table increases, so a plurality of printing products such as a printed printing product and its printing sample (a printing product serving as a criterion for proof printing) cannot be put on the printing sample table in measuring the printed printing product by the automatic scanning measuring device.

This entails an operation cumbersome for the operator, that is, an operation of moving the printing product and printing sample to different positions, and returning them on the printing sample table again after measurement.

### SUMMARY OF THE INVENTION

It is an object of the present invention to provide an ink supply amount control apparatus for a printing press, which obviates the need for an additional space.

It is another object of the present invention to provide an ink supply amount control apparatus for a printing press, which relieves the operator's burden.

In order to achieve the above-mentioned objects, according to the present invention, there is provided an ink supply amount control apparatus for a printing press, comprising a sheet delivery device which delivers a sheet printed by a printing press, a printing quality control device which is provided on the sheet delivery device, and at least adjusts an amount of ink to be printed on the sheet by a manual operation, a measuring device which is movably provided on the printing quality control device, and measures color adjustment data for each of color patches printed in margins of the sheet, and an ink amount adjusting device including a control unit which automatically adjusts an amount of ink to be printed on the sheet, based on a comparison result between the color adjustment data measured by the measuring device, and reference values set in advance.

According to the present invention, the need for an additional space can be obviated by integrally arranging, on a sheet delivery device of a printing press, a printing quality control device which adjusts an amount of ink to be printed on the sheet by a manual operation, and an ink amount adjusting device which automatically adjusts the amount of ink. Also, the operator can adjust the ink supply amount only at one position, thus relieving the operator's burden.

### BRIEF DESCRIPTION OF THE DRAWINGS

FIG. 1 is a side view showing the schematic arrangement of a sheet-fed offset rotary printing press to which an ink supply amount control apparatus according to an embodiment of the present invention is applied;

FIG. 2 is a side view of a sheet delivery device shown in FIG. 1;

FIG. 3 is a view when viewed from a direction indicated by an arrow III in FIG. 2;

FIG. 4 is a side view of the ink supply amount control apparatus shown in FIG. 1; and

FIG. 5 is an enlarged sectional view showing the main part of the ink supply amount control apparatus shown in FIG. 4.

### DESCRIPTION OF THE PREFERRED EMBODIMENT

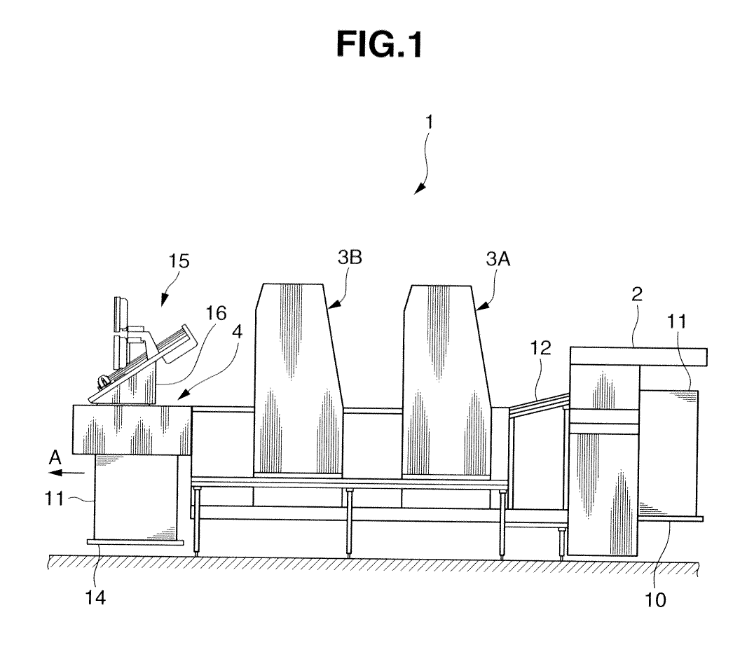

An embodiment of the present invention will be described below with reference to FIGS. 1 to 5.

A sheet-fed offset rotary printing press 1 includes a sheet feed device 2 which feeds sheets 11 stacked on a pile board 10, printing units 3A and 3B for respective colors, which print two colors on the sheets 11 fed from the sheet feed device 2, and a sheet delivery device 4 which delivers the sheets 11 conveyed from the printing unit 3B, as shown in FIG. 1.

In the sheet feed device 2, the sheets 11 stacked on the pile board 10 are drawn by suction one by one by a suction device (not shown), and fed to a feeder board 12. Then, the sheets 11 are transferred to the grippers of an impression cylinder (not shown) of the printing unit 3A via a swing arm shaft pregripper (not shown), and the first color is printed on them. The sheets 11 are further transferred to the grippers of an impression cylinder (not shown) of the printing unit 3B via a transfer cylinder (not shown), and the second color is printed on them.

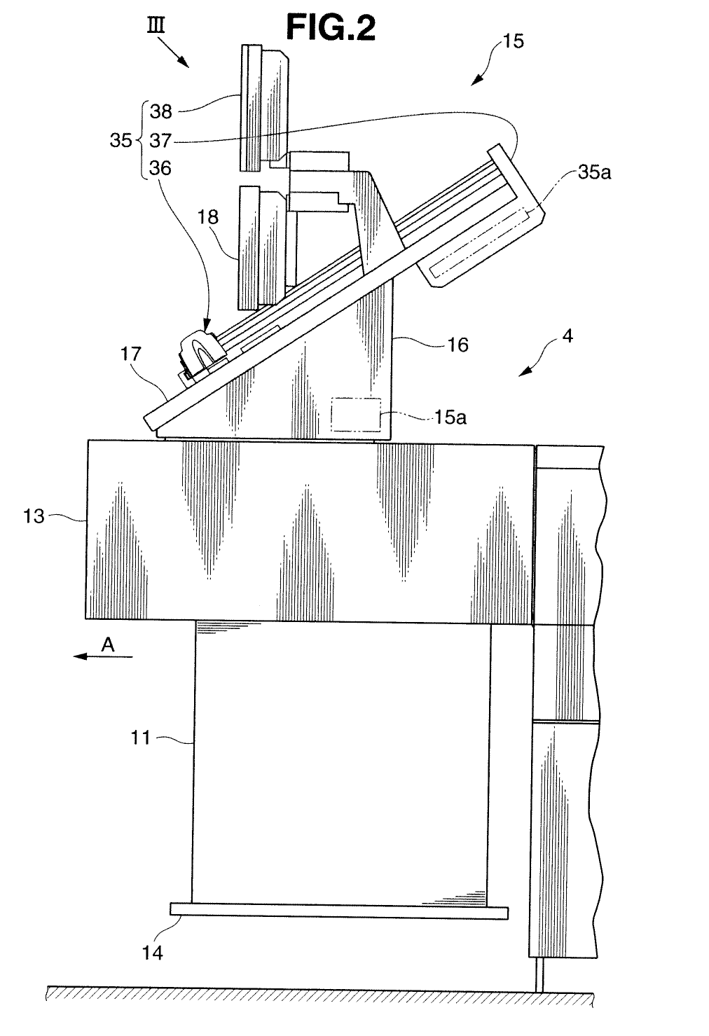

A pair of delivery frames 13 of the sheet delivery device 4 are provided with delivery chains (not shown) which use a sheet gripper device (not shown) to grip and convey the sheet 11 printed by the printing unit 3B for the second color, as shown in FIG. 2. The sheet 11 conveyed by the delivery chains is released from gripping of the sheet gripper device by a cam mechanism, and falls onto and is stacked on a pile board 14 provided below the conveyance terminal end. The printed sheet 11 stacked on the pile board 14 is pulled out forward by the operator who operates on the front side (in a direction indicated by an arrow A) of the sheet delivery device 4.

A printing quality control device 15 including an ink amount adjusting device with which the operator manually adjusts the amount of ink to be printed on the sheet 11 is provided on the sheet delivery device 4. The printing quality control device 15 includes a case 16 which is fixed on the delivery frames 13, has it upper portion open, and has a nearly triangular shape when viewed in a side view, an operation panel 17 which covers the opening in the upper portion of the case 16, and a control unit 15a mounted in the case 16, as shown in FIG. 2.

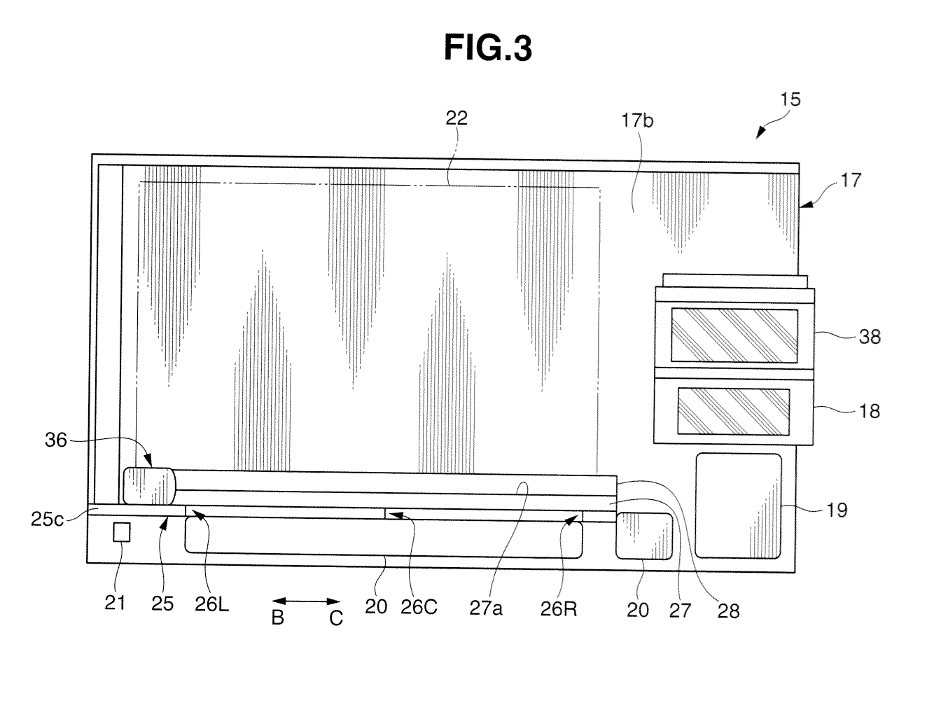

The control unit 15a mounted in the case 16 controls, for example, an inking device, dampening device, and register device in the sheet-fed offset rotary printing press 1 in accordance with the operator's manual operation, thereby adjusting the printing quality of the sheet 11. In this case, the operator performs, for example, the operation of an operation unit 19 or a touch panel (FIG. 3) of a display 18, and the operation of push buttons on a control plate 20 used to control ink fountain keys. The upper edges of the two side portions of the case 16 are inclined to be higher from the front to the rear, and the operation panel 17 is attached to the upper surface of the case 16 so that it is inclined to be higher from the front to the rear as well.

The operation panel 17 includes the touch panel display 18 which operates the inking device, the operation unit 19 including a plurality of push buttons used to issue instructions to operate, for example, the inking device, dampening device, and register device, the control plate 20, and a switch 21 which is used to manually turn on/off a suction pump (to be described later) and turn it off by time control, as shown in FIG. 3. A printing sample table (table portion) 22 on which the sheet 11 printed by the sheet-fed offset rotary printing press 1 is placed is integrally formed in a region on the operation panel 17, other than the display 18, the operation unit 19, the control plate 20, the switch 21, and a display 38 for an automatic ink amount adjusting device (to be described later).

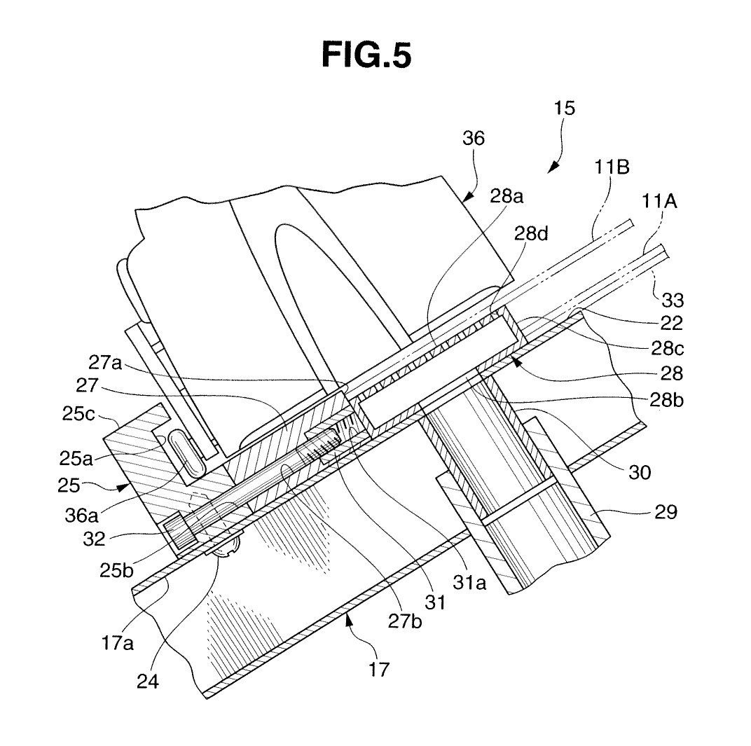

A traveling guide 25 having a U-shaped cross-section is attached to a portion below the printing sample table 22 to extend horizontally (in directions indicated by double-headed arrows B and C) over the entire length of the lower edge of the printing sample table 22. As shown in FIG. 5, the traveling guide 25 is fixed on a ceiling plate 17a of the operation panel 17 by a bolt 24, and uses a guide groove 25a to guide a measuring device 36 to be movable in the directions indicated by the double-headed arrows B and C. An insertion hole 25b into which a bolt 32 is inserted is formed in the lower portion of the traveling guide 25 in a direction perpendicular to the traveling guide 25. Marks 26C, 26L, and 26R to serve as references for the range of density measurement by the measuring device 36 are formed at the center and two end portions of an upper end surface 25c of the traveling guide 25, as shown in FIG. 3. The mark 26C indicates the central position of each ink fountain key, and the marks 26L and 26R indicate a criterion for the maximum measurement range.

A position regulating member 27 is attached to be in contact with the upper side surface of the proximal portion of the traveling guide 25 to extend over the entire length of the lower edge of the printing sample table 22, as shown in FIG. 5. The position regulating member 27 is used for longitudinal alignment of the sheet 11 in measuring a color bar on a printed sheet 11B by the measuring device 36. The position regulating member 27 includes a position regulating surface 27a which abuts against the trailing edge of the sheet 11B, and an insertion hole 27b into which the bolt 32 is inserted in a direction perpendicular to the traveling guide 25.

An air suction member 28 which has a flat, elongated rectangular parallelepiped shape and a hollow interior is juxtaposed to the position regulating member 27 over the entire length of the lower edge of the printing sample table 22. A large number of small holes 28d are formed in an entire suction surface 28a of the ceiling portion of the air suction member 28. A suction hole 28b is formed at one end of the bottom portion of the air suction member 28, and a pipe 29 is connected to the suction hole 28b via a hose nipple 30 to extend from a suction pump (not shown).

A connecting member 31 having a screw hole 31a formed in it is integrally fixed on the lower side surface of the air suction member 28. The bolt 32 which extends through the insertion hole 25b in the traveling guide 25 and the insertion hole 27b in the position regulating member 27 threadably engages with the screw hole 31a, thereby fixing the air suction member 28 onto the traveling guide 25 via the position regulating member 27. At this time, the upper surface (suction surface 28a) of the air suction member 28 projects to a level higher than the surface of the printing sample table 22 by an amount equal to the thickness of several sheets 11.

Upon fixation of the air suction member 28 onto the traveling guide 25, the position regulating member 27 is also fixed onto the traveling guide 25 while being clamped by the air suction member 28 and the traveling guide 25. The position regulating member 27 and air suction member 28 extend horizontally (in the directions indicated by the double-headed arrows B and C) to be slightly longer than the printing sample table 22 while being kept in contact with each other immediately under the printing sample table 22, as shown in FIG. 3. An upper side surface 28c of the air suction member 28 functions as a stopper which regulates a fall of a sheet 11A and printing sample 33 placed on the printing sample table 22, as shown in FIG. 5. The position regulating surface 27a of the position regulating member 27 projects to a level higher than the suction surface 28a of the air suction member 28 by an amount equal to or larger than the thickness of a single sheet, and regulates a fall of the sheet 11B having its trailing edge drawn by suction by the suction surface 28a.

The measuring device 36 is supported on the operation panel 17 upon engagement with the traveling guide 25, as shown in FIG. 5. The measuring device 36 has a roller 36a guided by the guide groove 25a in the traveling guide 25, and travels to be movable horizontally (in the directions indicated by the double headed arrows B and C). With the movement of the measuring device 36, color adjustment data for each color patch printed in the margin of the image on the sheet 11B is measured.

A case 37 which accommodates a control unit 35a that adjusts the amount of ink is fixed in the rear portion of the operation panel 17, as shown in FIG. 2. The control unit 35a compares the color adjustment data measured by the measuring device 36, and reference values set in advance to adjust the amount of ink to be printed on the sheet 11, based on the comparison result. The operation panel 17 supports not only the touch panel display 18 but also the touch panel display 38 which inputs a drive instruction to move the measuring device 36, and the measured density of each color patch, or a reference value for color adjustment for each color patch. The control unit 35a, measuring device 36, and display 38 arranged on the sheet delivery device 4 constitute an ink amount adjusting device 35 which automatically measures the density value of the color patch of each color on the printed sheet 11A to automatically adjust the amount of ink.

The control operation of the inking device, dampening device, and register device by the thus configured sheet-fed offset rotary printing press will he described next. When the sheet-fed offset rotary printing press 1 starts its test printing, the operator positions himself or herself close to the sheet delivery device 4 on the front side so as to keep the operation panel 17 within arm's reach. Then, the operator pulls out the printed sheet 11A serving as a final printing sample from the sheet delivery device 4, every time a predetermined number of sheets are printed.

The pulled-out sheet 11A is compared with the printing sample 33 by visual inspection. If the comparison result reveals that these two sheets have a difference, the operator manually operates the touch panel of the display 18, and the push buttons of the operation unit 19 and control plate 20 to adjust the ink feed rate and the dampening water feed rate, and perform longitudinal and lateral registration.

To measure the density value of the color patch of each color on the printed sheet 11A, the printing sample 33 and printed sheet 11A are temporarily placed on the printing sample table 22. At this time, the printed sheet 11A and printing sample 33 placed on the printing sample table 22 fall along the tilt of the printing sample table 22, and stop their fall upon contacting the upper side surface 28c of the air suction member 28.

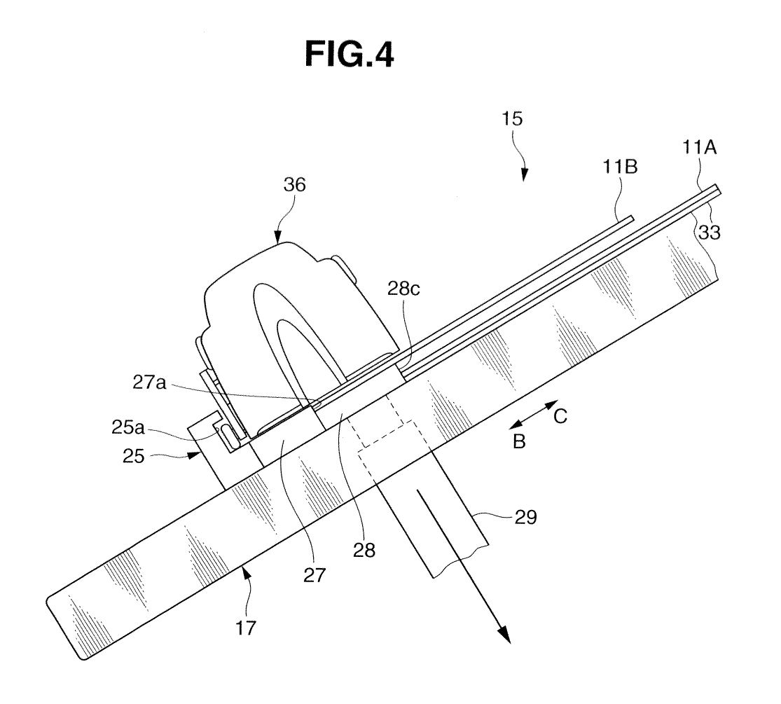

In this state, the operator pulls out the printed sheet 11B from the sheet delivery device 4, places the trailing edge of the sheet 11B on the suction surface 28a of the air suction member 28, as shown in FIG. 5, and aligns the trailing edge of the sheet 11B with the position regulating surface 27a of the position regulating member 27. The switch 21 is turned on so that the air suction member 28 starts its suction operation, thereby drawing by suction and fixing the trailing edge of the sheet 11B onto the suction surface 28a of the air suction member 28, as shown in FIG. 4.

Upon the operation of the touch panel of the display 38, the measuring device 36 moves horizontally (in the directions indicated by the double-headed arrows B and C) along the traveling guide 25, and measures the density value of the color patch of each color in the color bar printed in the margin of the trailing edge of the sheet 11B. The measured density value of the color patch of each color is compared with a reference density value for this color by the control unit 35a in the case 37. The opening ratio of the ink fountain key of each color is adjusted in accordance with the comparison result (the difference between the two values), and a printing product is printed using the reference density value for this color.

When the switch 21 is turned off, the air suction member 28 cancels its suction operation, so the sheet 11B after measurement is placed on the printing sample table 22. At this time, the trailing edge of the sheet 11B is stopped by the upper side surface 28c of the air suction member 28. Thus, the sheet 11B printed next can be measured by the measuring device 36.

According to this embodiment, since the ink amount adjusting device 35 including the measuring device 36 is provided on the sheet delivery device 4, the operator can pull out the printed sheet 11 from the sheet delivery device 4 while staying where he or she is. This makes it possible to easily perform the pull-out operation in a short time, thus improving the workability.

The printing quality control device 15 and ink amount adjusting device 35 are provided on the sheet delivery device 4 while being organically combined with each other. Especially because the measuring device 36 is provided on the operation panel 17 of the printing quality control device 15, there is no need to newly provide a space in which the ink amount adjusting device 35 is disposed. This makes it possible not only to save space but also to reduce the manufacturing cost. There is no need, either, to provide a wiring cable which is used to connect the printing press 1 and the ink amount adjusting device 35, and hinders the operation.

Moreover, since a stopper including the upper side surface 28c of the air suction member 28 is provided on the printing sample table 22, the printing sample 33 and the sheets 11A and 11B after measurement can he placed on the printing sample table 22. Thus, in measuring the printed sheet 11B by the measuring device 36, there is no need to place the printing sample 33 and the sheets 11A and 11B after measurement at different positions and return them to their original positions, thus obviating the need for an operation cumbersome for the operator.

Again, the position regulating member 27 which abuts against the trailing edge of the sheet 11B and aligns the longitudinal position of the sheet 11B, and the air suction member 28 which holds the trailing edge of the sheet 11B by suction are provided. Thus, in measuring the color bar on the sheet 11B by the measuring device 36, it is possible to prevent movement of the sheet 11B and warpage of the sheet 11B.

Although the operation panel 17 is tilted from the front of the sheet delivery device 4 to its rear in this embodiment, it may be tilted from one lateral side of the sheet delivery device 4 to its other lateral side. In this case, the operator need only perform the operation on the lateral side of the sheet delivery device 4. Also, although paper is used as a sheet, the present invention is applicable to various sheet-shaped objects such as a vinyl chloride sheet.

Also, although the use of an ink amount adjusting device including an automatic scanning measuring device which measures the density value of each color patch has been described above, an ink amount adjusting device which includes a color value measuring device in place of a density value measuring device may be used. In this case, a spectrometer can be used as the color value measuring device. Instead of the density value of the color patch of each color, the color value of the color patch of each color is measured by the spectrometer, the measured color value of the color patch of each color is compared with a reference color value for this color, and a printing product is printed using the reference color value for this color.

What is claimed is:

1. An ink supply amount control apparatus for a printing press, comprising:
a sheet delivery device which delivers a sheet printed by a printing press;
a printing quality control device which is provided on said sheet delivery device, and at least adjusts an amount of ink to be printed on the sheet by a manual operation;
a measuring device which is movably provided on said printing quality control device, and measures color adjustment data for each of color patches printed in margins of the sheet; and
an ink amount adjusting device including a control unit which automatically adjusts an amount of ink to be printed on the sheet, based on a comparison result between the color adjustment data measured by said measuring device, and reference values set in advance.

2. An apparatus according to claim 1, further comprising:
a table portion on which the sheet is placed when said measuring device measures the color patches on the sheet;
a position regulating member which abuts against a trailing edge of the sheet and aligns a longitudinal position of the sheet when said measuring device measures the color patches on the sheet; and
an air suction member which holds by suction the trailing edge of the sheet when said measuring device measures the color bars on the sheet,
wherein said table portion, said position regulating member, and said air suction member are provided to said printing quality control device.

3. An apparatus according to claim 2, wherein
said printing quality control device includes an operation panel attached to a portion above said sheet delivery device,
said table portion is provided in a partial region of said operation panel, and
said position regulating member and said air suction member are attached to a lower edge of said table portion.

4. An apparatus according to claim 3, further comprising:
a traveling guide which extends over an entire length of the lower edge of said table portion, and guides traveling of said measuring device,
wherein said position regulating member and said air suction member are juxtaposed to each other and fixed in position while being kept in contact with said traveling guide to extend over the entire length of the lower edge of said table portion.

5. An apparatus according to claim 4, wherein said position regulating member has a position regulating surface which projects to a level higher than a suction surface of said air suction member by an amount that is not less than a thickness of a single sheet, and regulates a fall of the sheet which is sucked by the suction surface of said air suction member.

6. An apparatus according to claim 4, wherein said air suction member has a suction surface which projects to a level higher than a surface of said table portion by an amount equal to a thickness of several sheets, and sucks the trailing edge of the sheet placed on said table portion.

7. An apparatus according to claim 6, wherein a plurality of small holes are formed in the entire suction surface of said air suction member.
